(19) United States
(12) Patent Application Publication
(10) Pub. No.: US 2003/0040335 A1
(43) Pub. Date: Feb. 27, 2003

(54) Tower top cellular communication devices and method for operating the same

(76) Inventors: Chris P. McIntosh, San Francisco, CA (US); Kui Lin, Redwood City, CA (US)

Correspondence Address: FLEHR HOHBACH TEST ALBRITTON & HERBERT LLP, Suite 3400, Four Embarcadero Center, San Francisco, CA, 94111-4187, US

(21) Appl. No.: 10/076,810

(22) Filed: Feb. 13, 2002

Related U.S. Application Data
(63) Continuation-in-part of application No. 09/940,279, filed on Aug. 27, 2001.
(60) Provisional application No. 60/353,851, filed on Jan. 31, 2002.

(51) Int. Cl. H04B 1/38

(52) U.S. Cl. 455/561

(57) ABSTRACT

A 3G network (100) and method are provided that reduce loses between a base transceiver station (node B 102) and an antenna (114). Generally, the network (100) includes a tower (112) having a tower-top (110) on which the antenna (114) is supported, a node B (102) and a separate amplifier (124) on the tower-top near to the antenna, the amplifier in a communication path between the node B and the antenna. In one embodiment, the network (100) further includes a backhaul (122) on the tower-top (110) near the antenna (114), the backhaul configured to couple signals between the node B (102) and a radio network controller (RNC 108). Preferably, the backhaul (122) is integrated with the node B (102). In another version, the backhaul (122) is configured to couple communication signals between the node B (102) and the RNC (108) via a 3G network (128). More preferably, a photovoltaic cell (132) on the tower (112) supplies electrical power to the node B (102), the amplifier (124) and the backhaul (122), thereby providing a self-contained tower-top node (134).

### REFERENCE TO RELATED APPLICATIONS

This application claims priority to U.S. Provisional Application Serial No. ______, (attorney docket number P-70598-1) entitled Tower Top Cellular Communication Devices and Method for Operating the Same, filed Jan. 31, 2002, and is a continuation-in-part of U.S. patent application Ser. No. 09/940,279, entitled Tower Top Cellular Communication Devices and method for Operating the Same, filed Aug. 27, 2001, both of which are incorporated herein by reference.

### TECHNICAL FIELD

The present invention relates generally to cellular communication systems, and more particularly to a third generation cellular communication network having a tower top node B with an integrated backhaul and a method for operating the same.

### BACKGROUND

The use of mobile communication devices including cellular telephones, pagers and wireless internet access appliances has increased exponentially in recent years. This increased demand for mobile communication devices has led to rapid growth in the infrastructure required to support these services.

A block diagram of a conventional third generation cellular communication network (3G network) for communicating with UEs or user equipment terminals (UEs), is shown in FIG. 1. Referring to FIG. 1, a conventional 3G network 10 for communicating with a UE 12 typically includes a third generation mobile switching center (3G-MSC 14) that communicates with a public switched telephone network (PSTN 16), a gateway support node (GSN 15) that communicates with an IP network, such as the Internet 17, and a number of radio network controllers (RNC 18), only one of which is shown. The 3G-MSC 14 and GSN 15 further couple to a home location registry (HLR 19) which records and store address and authorization or authentication information of system subscribers. Each RNC 18 communicates with one or more node Bs 20. The node Bs 20 are coupled via a feed cable 22 to one or more antennas 24 mounted on top of a tower 26 and are responsible for transmitting and receiving communication signals between the 3G network 10 and the UE 12. Each node B 20 commonly includes one or more transceivers for transmitting and receiving signals, amplifiers for amplifying received and transmitted signals, a diplexor or multiplexer for applying transmitted signals to the antenna 24 and splitting the received signals onto a receive line, and a backhaul for coupling signals between the node B and the RNC 18.

The 3G-MSC 14 communicates with the RNC 18 using an established protocol such as, for example, CDMA (Code Division Multiple Access) and TDMA (Time Division Multiple Access) protocols. These various protocols dictate the nature of the communications between the 3G-MSC 14, the RNCs 18, and the node Bs 20 and are well known to those skilled in the art. The GSN 15 acts as a gateway between the 3G network 10 and the Internet 17, translating between the protocols used within the 3G network and the packet based communication of the Internet.

Conventional RNCs 18 are primarily responsible for dictating the size of an associated cell or area covered or served by a particular node B 20. There are no fixed specifications as to the size of the cells, but in current usage, it is common to refer to macro-cells, mini-cells, micro-cells and pico-cells. The range of the various cells tends to vary with their size and by way of example in current usage, macro-cells typically have antennas 24 that output on the order of 20-50 watts of energy and tend to have ranges on the order of 5-40 kilometers. Mini-cells typically have power outputs on the order of 10 watts and corresponding ranges in the vicinity of 2-5 kilometers. Micro-cells typically have power consumption on the order of 2-8 watts with ranges of a kilometer or so. Of course as signal processing capabilities in antenna designs improve, the distinction between the various sizes blurs but in concept, the cell size may always be varied.

One problem frequently encountered by conventional 3G networks having the antenna 24 on top of the tower 26 arises from the feed cable 22 coupling communication signals between the node B 20 and the antenna. In the illustrated arrangement, the antenna 24 is mounted on the top of the tower 26 while the associated node B 20 is at the base of the tower. Thus, if the tower 26 is tall, a long feed cable 22 must be provided between the node B and the antenna 24. Moreover, often the node B 20 is located some distance away from the tower 26 in a location more protected from the environment or more readily accessible by maintenance personnel, further lengthening the feed cable 22. Generally the feed cable 22 includes a pair of coax cables with one coax cable (a transmit line) being arranged to carry the transmit signal and one coax cable (a receive line) being arranged to carry the receive signal. Often, the transmit and receive line can be combined in a single multiplexed feed cable 22. A long feed cable 22 presents several difficulties including significant signal intensity or power losses in both received and transmitted signals, and signal degradation by the introduction of noise to the received signal.

Another problem with conventional 3G networks is the difficulty in upgrading or modifying the node B 20 hardware to alter size and/or shape of a particular cell. For example, as wireless communication technology increases in popularity it is often desirable to reduce the size of a cell to permit the introduction of additional cells in order to handle higher usage. In other instances it is desirable to increase the size of a cell to provide improved range. Although the present designs work well, they are not particularly modular in that if it is desirable to change the size of a cell for any reason, it is necessary to replace the entire node B 20, rather than just an amplifier, diplexor, backhaul or transceivers contained therein. Conventional node Bs 20 are relatively large and expensive units. Thus, it is desirable to provide a node B architecture that enables the node B components to be upgraded, repaired or replaced independently and even reused if the reason for replacement was merely to change cell size or cell geometry.

The present invention provides a solution to these and other problems, and offers other advantages over the prior art.

### SUMMARY

It is an object of the present invention to provide a communication system or network having a tower-top amplifier, communication device and backhaul and a method for operating the same.

In one aspect, the present invention is directed to a node B for communicating with a user equipment terminal (UE) through an antenna supported on a top of a tower in a 3G communication system or network. Generally, the node B is configured to be affixed to the tower-top in a location proximal to the antenna, thereby reducing losses associated with coupling communication signals between the antenna and the node B. Preferably, the node B reduces losses associated with coupling communication signals between the antenna and the node B by at least 3 dB over a cellular communication system in which the node B is not affixed to the tower-top in a location proximal to the antenna. More preferably, the node B is capable of providing an outgoing communication signal from the antenna having a power of at least about 40 dBm, and most preferably of at least about 27 dBm.

In one embodiment, the 3G network further includes a radio network controller (RNC), and the node B includes: (i) at least one transceiver adapted to communicate with the UE through the antenna; (ii) a power amplifier in a communication path between the transceiver and the antenna, the power amplifier adapted to amplify outgoing communication signals received from the RNC, and to output amplified communication signals; and (iii) a power supply for supplying power to the power amplifier and the transceiver. Integrating the power amplifier into the tower-top node B and providing a common power supply reduces the size, complexity, cost and electrical power consumption of the node B over a 3G network having a separate power amplifier at the tower-top and node B located elsewhere. Optionally, the node B can further include a diplexor for coupling amplified communication signals from the power amplifier to the antenna, and coupling incoming communication signals from the antenna to the transceiver.

In another embodiment, the node B further includes a backhaul for coupling communication signals between the node B and the RNC. In one version of this embodiment, the backhaul is configured to couple communication signals between the node B and the RNC via a separate wireless communication system. In another version, the node B receives power from at least one photovoltaic cell affixed to the tower to provide a self-contained tower-top node.

In another aspect, the present invention is directed to a 3G communication system or network including: (i) an antenna; (ii) a tower having a tower-top on which the antenna is supported; (iii) a node B affixed to the tower-top in a location proximal to the antenna, the node B having at least one transceiver configured to communicate with a UE through the antenna; and (iv) an amplifier affixed to the tower-top in a location proximal to the antenna, the amplifier in a communication path between the node B and the antenna, and separate and distinct from the node B, the amplifier configured to amplify and filter communication signals passed between the node B and the UE. Preferably, the 3G network reduces losses associated with coupling communication signals between the node B and the amplifier, and between the amplifier and the antenna are reduced by at least 3 dB over a 3G network not having a node B and an amplifier affixed to the tower-top in a location proximal to the antenna. More preferably, the amplifier is capable of providing an outgoing communication signal from the antenna having a power of at least about 40 dBm, and most preferably of at least about 39 dBm.

In one embodiment, the 3G network further includes a radio network controller (RNC), and a backhaul affixed to the tower-top in a location proximal to the antenna, the backhaul configured to couple communication signals between the node B and the RNC. In one version of this embodiment, the backhaul is integrated with the node B. In another version, the backhaul is configured to couple communication signals between the node B and the RNC via a separate wireless communication system.

In another embodiment, the 3G network further includes at least one photovoltaic cell affixed to the tower for supplying electrical power to the node B, the amplifier and the backhaul, thereby providing a self-contained tower-top node.

In still another aspect, the present invention is directed to a method for facilitating communication with a UE in a 3G network having an antenna supported on a top of a tower. Generally, the method includes the steps of: (i) providing a node B affixed to the top of the tower in a location proximal to the antenna, the node B having at least one transceiver configured to communicate with a UE through the antenna; (ii) providing an amplifier affixed to the top of the tower in a location proximal to the antenna, the amplifier in a communication path between the node B and the antenna, and separate and distinct from the node B, the amplifier configured to amplify and filter communication signals passed between the node B and the UE; (iii) operating the at least one transceiver to communicate with the UE; and (iv) amplifying and filtering communication signals passed between the node B and the UE. As noted above losses associated with coupling communication signals between the node B and the amplifier, and between the amplifier and the antenna are reduced over a 3G network not having a node B and an amplifier affixed to the top of the tower in a location proximal to the antenna. Preferably, losses associated with coupling communication signals between the antenna and the node B are reduced by at least 3 dB. More preferably, the step of amplifying and filtering communication signals passed between the node B and the UE involves the step of transmitting an outgoing communication signal from the antenna having a power of at least 39 dBm.

In one embodiment, the 3G network further includes a radio network controller (RNC), and a backhaul affixed to the top of the tower in a location proximal to the antenna and configured to couple communication signals between the node B and the RNC, and the method involves the further step of coupling communication signals between the node B and the RNC using the backhaul. In one version of this embodiment, the backhaul is configured to couple communication signals between the node B and the RNC via a separate wireless communication system, and the step of coupling communication signals between the node B and the RNC using the backhaul is accomplished by coupling communication signals between the node B and the RNC via the separate wireless communication system.

In another embodiment, the 3G network further includes at least one photovoltaic cell affixed to the tower, and the method involves the further step of supplying electrical power to the node B, the amplifier and the backhaul from the photovoltaic cell.

Advantages of the 3G network and method of the present invention include any one or all of the following:

(i) reduced losses associated with coupling communication signals between the node B and the amplifier, and between the amplifier and the antenna over a 3G network not having a node B and an amplifier affixed to the tower-top in a location proximal to the antenna;

(ii) an outgoing communication signal from an antenna of a tower-top node having a power of at least 39 dBm;

(iii) improved received sensitivity due to significant reduction in overall noise achieved by minimizing losses between the antenna and receive system;

(iv) modular architecture facilitating repair, upgrade and repair of one of the amplifier, node B and backhaul independent of the other modules; and

(v) a self-contained node capable of operating independent from a connection to public power line or a land based communication line to a radio network controller.

### BRIEF DESCRIPTION OF THE DRAWINGS

These and various other features and advantages of the present invention will be apparent upon reading of the following detailed description in conjunction with the accompanying drawings, where:

FIG. 1 (prior art) is a block diagram of a conventional 3G network;

FIG. 2 is a block diagram of a 3G network having a tower-top node B according to an embodiment of the present invention;

FIG. 3 is a block diagram of a 3G network having a tower-top amplifier and node B according to an embodiment of the present invention;

FIG. 4 is a block diagram of a 3G network having a tower-top amplifier, node B and backhaul according to an embodiment of the present invention;

FIG. 5 is a partial block diagram of a 3G network showing a tower-top amplifier, node B with an integrated backhaul according to an embodiment of the present invention;

FIG. 6 is a block diagram of a 3G network having a tower-top backhaul coupled to a radio network controller via a separate wireless communication system according to an embodiment of the present invention;

FIG. 7 is a flow chart showing steps of a method for facilitating communication with a UE using a tower-top node according to an embodiment of the present invention; and

FIG. 8 is a partial block diagram of a 3G network showing a tower-top node B, RNC, GSN and UIB according to an embodiment of the present invention.

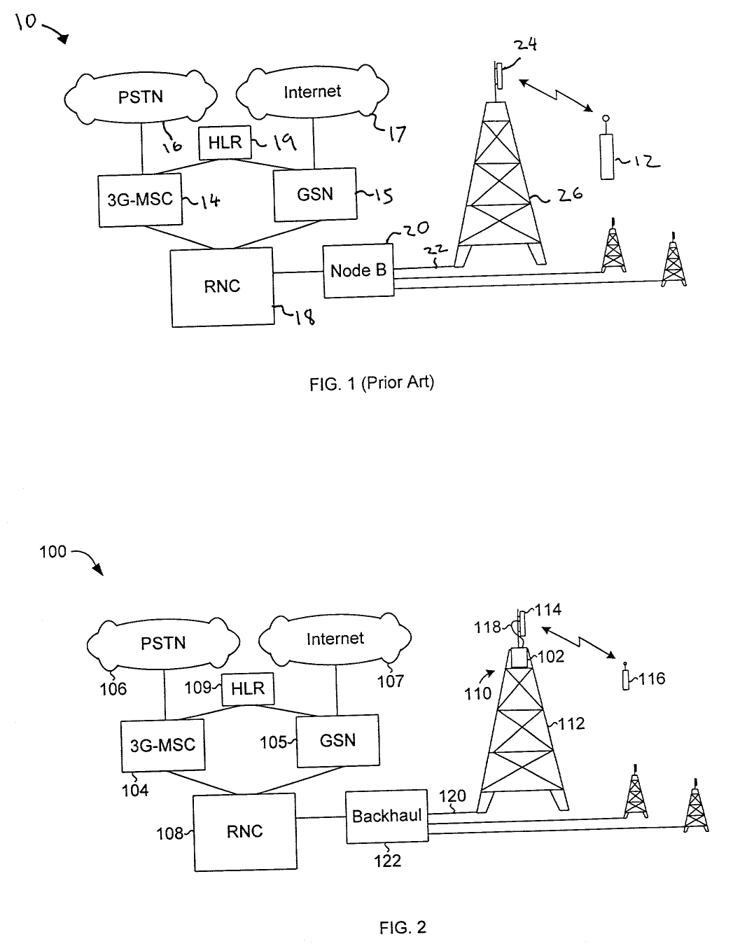

### DETAILED DESCRIPTION

The present invention is directed to a communication system or network having a tower-top amplifier, a communication device and backhaul and a method for operating the same to provide reduced loses between the communication device and an antenna supported by the tower, and to provide a higher power to outgoing signals transmitted from the antenna.

A communication system or network according to the present invention will now be described with reference to FIG. 2. FIG. 2 is a block diagram of a third generation cellular communication network (3G network 100) having a tower-top or pico node B 102 or iNode B according to an embodiment of the present invention. For purposes of clarity, many of the details of 3G networks 100 that are widely known and are not relevant to the present invention have been omitted. Referring to FIG. 2, the 3G network 100 generally includes: a mobile switching center (3G-MSC 104) that is coupled to and communicates with a public switched telephone network (PSTN 106), a gateway support node (GSN 105) that is coupled to and communicates with the Internet (107), and a number of radio network controllers (RNC 108), only one of which is shown. The 3G-MSC 104 and GSN 105 further couple to a home location registry (HLR 109) which records and store address and authorization or authentication information of system subscribers. Each RNC 108 communicates with one or more node Bs 102.

In accordance with the present invention, the node Bs 102 are mounted or affixed on a tower-top 110 of a tower 112, which also supports one or more antennas 114 for transmitting and receiving communication signals between the 3G network 100 and a user equipment terminal (UE 116). The node B 102 is coupled to the antenna 114 through an antenna-line 118, such as a co-axial cable, and to the RNC 108 via a land-line 120 or trunk. The land-line 120 can include a twisted pair, a fiber optic link, a co-axial cable or an E1/T1 line or trunk, and may include a pathway over PSTN 106 or an internet protocol (IP) network.

Preferably, the tower top node B 102 is completely contained within a module measuring less than 12 inches square and 1 to 2 inches deep, as compared with a conventional node B which is typically 3 feet tall, 2 feet wide and 2 feet deep. This modular architecture facilitates installation, repair, upgrade and replacement of the node B 102, providing a significant cost advantage over conventional systems. Generally, each node B 102 includes: one or more transceivers (not shown) for transmitting communication signals to and receiving communication signals from the UE 116; amplifiers (not shown) for amplifying received and transmitted communication signals; and a diplexor or multiplexor (not shown) for coupling outgoing communication signals to the antenna 114 and coupling received incoming communication signals to the transceivers. The amplifiers in the node B 102 can include a low noise amplifier, for amplifying and/or filtering an incoming communication signal coupled between the antenna 114 and the transceivers, and a power amplifier for amplifying an outgoing communication signal coupled from the transceiver to the antenna.

Affixing the node B 102 to the tower-top 110 of the tower 112 in a location or position near or proximal to the antenna 114 significantly reduces the length of the antenna-line 118, thereby significantly reducing losses associated with coupling communication signals between the antenna and the node B. Preferably, the node B 102 reduces losses associated with coupling communication signals between the antenna 114 and the node B by at least 3 dB over a conventional 3G network in which the node B is not affixed to the tower-top in a location proximal to the antenna. More preferably, by locating the node B 102, including the power amplifier for amplifying outgoing communication signals therein, on the tower 112 near or proximal to the antenna 114 provides an outgoing communication signal from the antenna having a higher power than possible with conventional systems having an amplifier with comparable gain. Most preferably, the node B 102 is capable of providing an outgoing communication signal from antenna 114 having a power of from at least about 27 dBm to at least 40 dBm.

In addition, the 3G network 100 further includes a backhaul 122 for interfacing between the node B and the RNC 108, and for coupling communication signals over the land-line 120. The backhaul 122 can be integrated within the node B 102 or separate therefrom as shown. Generally, the backhaul 122 includes circuits for adapting rate of communication signals used in the node B 102 to that of communication signals transferred over the land-line 120, and for converting between different protocols used in the node B and the RNC 108.

Electrical power to the backhaul 122, the node B 102 and to the transceivers, amplifiers, and diplexor therein, is supplied from a power supply (not shown), which may be integrated in the node B or located elsewhere on or near the tower 112. The power supply in turn generally receives power from a conventional external power source, such as a line from an electric power or utility company.

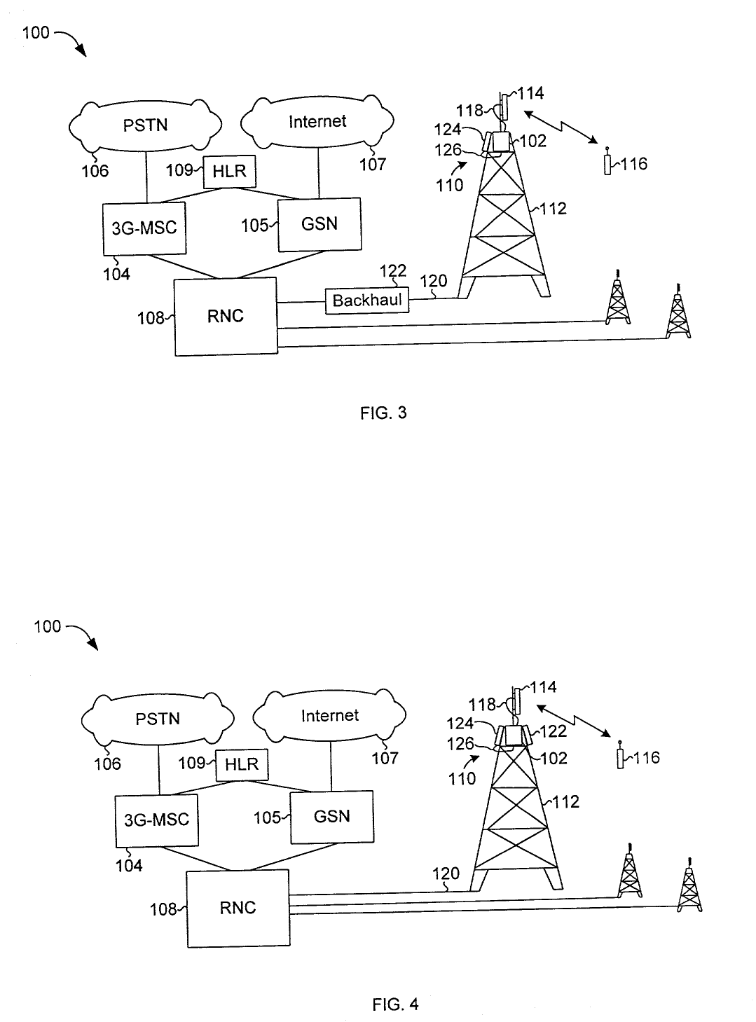

FIG. 3 is a block diagram of another embodiment of a 3G network 100 according to the present invention having a tower-top node B 102 and a tower-top amplifier or amplifier 124. Generally, the embodiment of 3G network 100 shown in FIG. 3, similar to the embodiment in FIG. 2 described above, includes a 3G-MSC 104, a number of RNCs 108, only one of which is shown, a number of node Bs 102 and associated towers 112, each with at least one antenna 114 supported thereon. However, in the embodiment of FIG. 3, the 3G network 100 further includes a separate power amplifier, amplifier 124, mounted or affixed on the tower-top 110 of the tower 112 in a location or position near or proximal to the antenna 114 for amplifying outgoing communication signals coupled from the transceiver in the node B 102 to the antenna. The amplifier 124 is coupled to the antenna 114 via the antenna-line 118 and to the node B 102 via a short feed-line 126. The amplifier 124 can be in place of or in addition to an internal power amplifier contained within the node B 102. Because of the power demands and heat dissipation requirements of large or high-gain power amplifiers, providing an amplifier 124 separate and distinct from the node B 102 enables use of larger a amplifier for greater gain and a smaller node B. Preferably, the amplifier is capable of providing an outgoing communication signal from the antenna having a power of at least about 39 dBm. More preferably, locating the amplifier 124 near to the antenna 114 and to the node B 102 reduces losses associated with coupling communication signals between the node B and the amplifier, and between the amplifier and the antenna by at least 3 dB over a 3G network not having a node B and an amplifier affixed to the tower-top in a location proximal to the antenna. Moreover, minimizing losses between the antenna 114 and the receive system or receiver (not shown) in the node B 102 improves received sensitivity, and the overall noise figure is significantly reduced by an amount equivalent to the loss that would be realized between the antenna and the receiver in a conventional system.

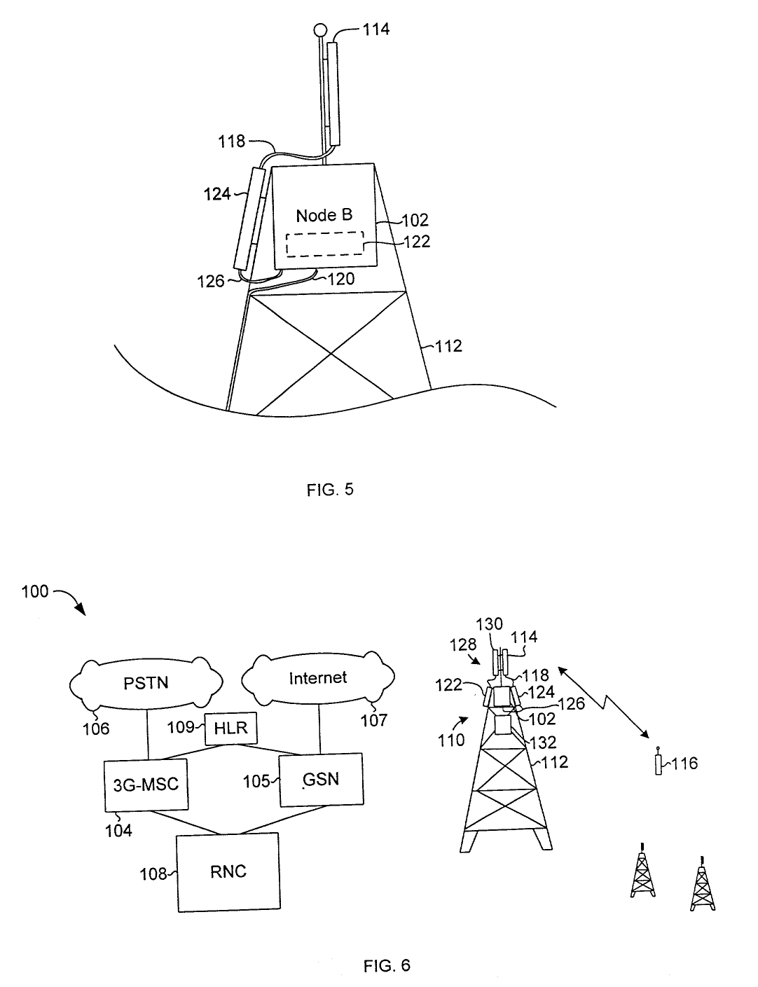

FIG. 4 is a block diagram of a 3G network 100 having a tower-top amplifier 124, a node B 102 and a backhaul 122 according to an embodiment of the present invention. The embodiment of the 3G network 100 shown in FIG. 4, differs from that described above in that the backhaul 122 is also located on the tower-top 110 of the tower 112 near or proximal to the antenna 114 and the node B 102, thereby reducing or eliminating losses and/or degradation in communication signals coupled between the backhaul and the node B. In a preferred embodiment, shown in FIG. 5 the backhaul 122 is integrated within the node B 102.

FIG. 6 is a block diagram of yet another embodiment of a 3G network 100 according to the present invention having a tower-top backhaul 122 coupled to the RNC 108 via a separate wireless network 128. Generally, the 3G network 100 includes a tower-top node B 102, an amplifier 124 and a backhaul 122, all separate and distinct from one another, and all mounted or affixed to tower-top 110 of tower 112 in a location or position near or proximal to antenna 114. Backhaul 122 couples communication signals from node B 102 to RNC 108 via a separate wireless network 128 including a directional antenna or antenna 130, thereby eliminating the land-line 120. Elimination of the landline 120 enables the tower 112 and the node B 102 associated therewith to be separated from a network of provider land-lines linking to other node Bs and to the RNC 108. Additionally, it allows a more rapid creation of a micro-cell to expand capacity within an existing macro-cell to meet an increase in demand. Although the backhaul 122 is shown as separate from the node B 102, it will be appreciated that the above embodiment is also applicable to 3G networks 100 wherein the backhaul is integrated with the node B.

Optionally, the 3G network 100 can further include a solar or photovoltaic cell 132 or an array of photovoltaic cells, on the tower 112 and a battery (not shown) to provide electrical power to the node B 102, the amplifier 124 and the backhaul 122, thereby eliminating the need for a connection to an electrical power line. Eliminating the need for a connection to an electrical power line provides a self-contained tower-top node 134 that can be located in areas geographically separated from utilities and the network of provider land-lines, in areas heretofore not serviced by a 3G network 100. Power requirements for each of the node B 102, the amplifier 124, and the backhaul 122 are from about 20 to about 35 watts, depending on the desired range or size of the associated cell, well within the capacity of commercially available photovoltaic cells 132 and batteries.

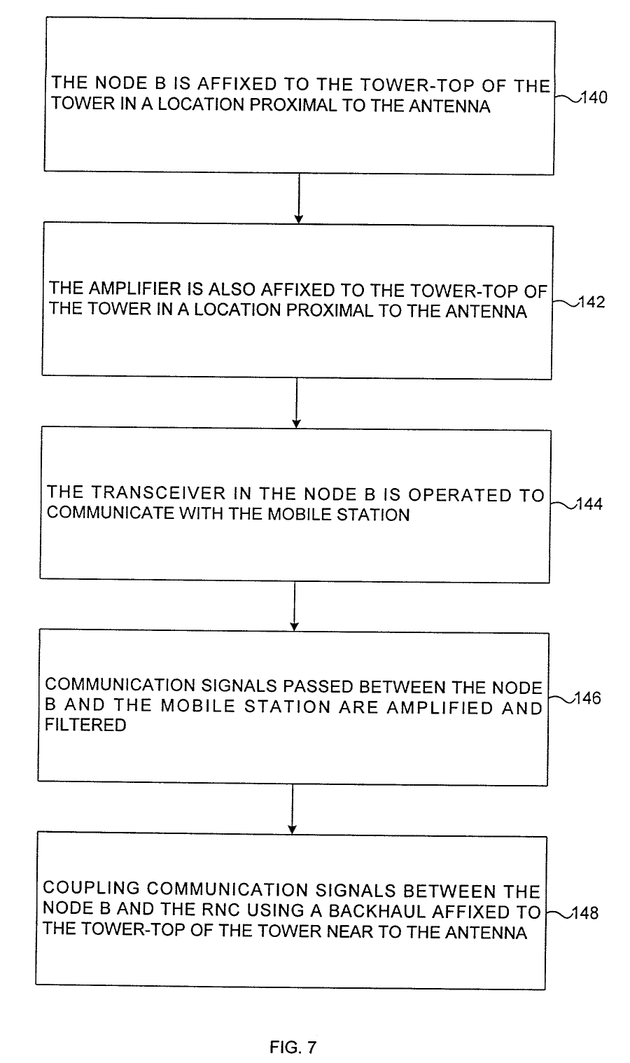

A method or process for operating a 3G network 100 according to an embodiment of the present invention will now be described with reference to FIG. 7. FIG. 7 is a flowchart showing steps of a method for facilitating communication with a UE 116 using a 3G network having a tower-top node B 102, amplifier 124 and/or backhaul 122. In the method, the node B 102 is affixed to the tower-top 110 of the tower 112 in a location proximal to the antenna 114 (step 140). The node B 102 has at least one transceiver configured to communicate with the UE 116 through the antenna 114. The amplifier 124 is also affixed to the tower-top 110 of tower 112 in a location proximal to the antenna 114 (step 142). The amplifier 124 is in a communication path between the node B 102 and the antenna 114, and is configured to amplify and filter communication signals passed between the node B and the UE 116. The transceiver in the node B 102 is operated to communicate with the UE 116 (step 144), and communication signals passed between the node B and the UE are amplified and filtered (step 146).

Preferably, losses associated with coupling communication signals between the antenna 114 and the node B 102 are reduced by at least 3 dB over conventional 3G networks not having tower-top node Bs and amplifiers. More preferably, the step of amplifying and filtering communication signals passed between the node B 102 and the UE 116, step 146, involves the step of transmitting an outgoing communication signal from antenna 114 having a power of at least 39 dBm.

In one embodiment, the method involves the further step of coupling communication signals between the node B 102 and the RNC 108 using a backhaul 122 affixed to the tower-top 110 of the tower 112 near to the antenna 114 (step 148). In one version of this embodiment, the step of coupling communication signals between the node B 102 and the RNC 108 using the backhaul 122, step 148, is accomplished by coupling communication signals between the node B and the RNC via a separate wireless communication system 128.

Optionally, the method further includes the initial step (not shown) of supplying electrical power to the node B 102, the amplifier 124 and the backhaul 122 from a photovoltaic cell 132 affixed to the tower 112.

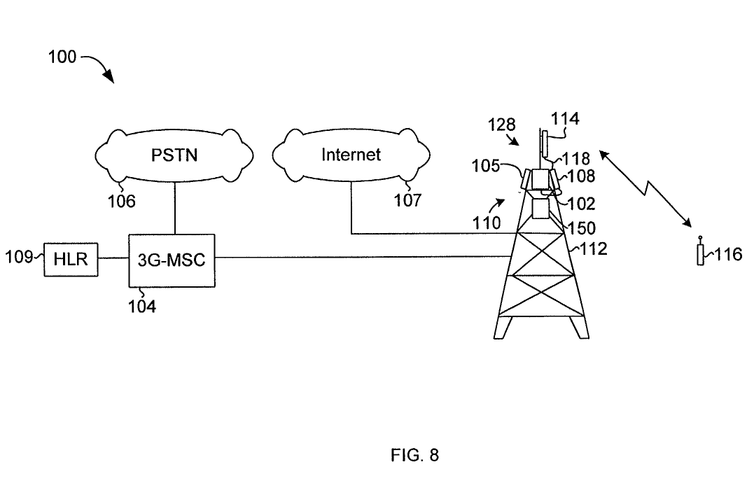

In an alternative embodiment, shown in FIG. 8, the communication system or 3G network 100 of the present invention can include a tower top RNC 108, a tower top GSN 105 or 3G-GSN, a tower top Iub 150 (interface between the RNC and Node B), or any combination thereof to further reduce losses associated with coupling of communication signals.

The foregoing description of specific embodiments and examples of the invention have been presented for the purpose of illustration and description, and although the invention has been illustrated by certain of the preceding examples, it is not to be construed as being limited thereby. They are not intended to be exhaustive or to limit the invention to the precise forms disclosed, and obviously many modifications, embodiments, and variations are possible in light of the above teaching. It is intended that the scope of the invention encompass the generic area as herein disclosed, and by the claims appended hereto and their equivalents.

What is claimed is:

1. A node B for communicating with a UE through an antenna supported on a top of a tower in a 3G network, the node B configured to be affixed to the tower-top in a location proximal to the antenna,
whereby losses associated with coupling communication signals between the antenna and the node B are reduced.

2. A node B according to claim 1, wherein the node B reduces losses associated with coupling communication signals between the antenna and the node B by at least 3 dB over a 3G network in which the node B is not affixed to the tower-top in a location proximal to the antenna.

3. A node B according to claim 2, wherein the node B is capable of providing an outgoing communication signal from the antenna-having a power of at least 27 dBm.

4. A node B according to claim 1, wherein the 3G network further includes a radio network controller (RNC), and wherein the node B comprises:
at least one transceiver adapted to communicate with the UE through the antenna;
a power amplifier in a communication path between the at least one transceiver and the antenna, the power amplifier adapted to amplify outgoing communication signals received from the RNC, and to output amplified communication signals; and
a power supply for supplying power to the power amplifier and the at least one transceiver,
whereby the size, complexity and electrical power consumption of the node B are reduced.

5. A node B according to claim 4, wherein the node B further comprises a backhaul configured to couple communication signals between the node B and the RNC.

6. A node B according to claim 5, wherein the backhaul is configured to couple communication signals between the node B and the RNC via a 3G network.

7. A node B according to claim 6, wherein the node B is configured to receive electrical power supplied by at least one photovoltaic cell affixed to the tower, whereby a self-contained tower-top node is provided.

8. A 3G network comprising:
an antenna;
a tower having a tower-top on which the antenna is supported;
a node B affixed to the tower-top in a location proximal to the antenna, the node B having at least one transceiver configured to communicate with a UE through the antenna; and
an amplifier affixed to the tower-top in a location proximal to the antenna, the amplifier in a communication path between the node B and the antenna, and separate and distinct from the node B, the amplifier configured to amplify and filter communication signals passed between the node B and the UE.

9. A 3G network according to claim 8, wherein losses associated with coupling communication signals between the node B and the amplifier, and between the amplifier and the antenna are reduced by at least 3 dB over a 3G network not having a node B and an amplifier affixed to the tower-top in a location proximal to the antenna.

10. A 3G network according to claim 8, wherein the amplifier is capable of providing an outgoing communication signal from the antenna having a power of at least 39 dBm.

11. A 3G network according to claim 8, further comprising a radio network controller (RNC), and a backhaul affixed to the tower-top in a location proximal to the antenna, the backhaul configured to couple communication signals between the node B and the RNC.

12. A 3G network according to claim 11, wherein the backhaul is integrated with the node B.

13. A 3G network according to claim 11, wherein the backhaul is configured to couple communication signals between the node B and the RNC via a network.

14. A 3G network according to claim 13, further comprising at least one photovoltaic cell affixed to the tower for supplying electrical power to the node B, the amplifier and the backhaul, whereby a self-contained tower-top node is provided.

15. In a 3G network having an antenna supported on a top of a tower, a method for facilitating communication with a UE, the method comprising steps of:
providing a node B affixed to the top of the tower in a location proximal to the antenna, the node B having at least one transceiver configured to communicate with a UE through the antenna;
providing an amplifier affixed to the top of the tower in a location proximal to the antenna, the amplifier in a communication path between the node B and the antenna, and separate and distinct from the node B, the amplifier configured to amplify and filter communication signals passed between the node B and the UE;
operating the at least one transceiver to communicate with the UE; and
amplifying and filtering communication signals passed between the node B and the UE,
whereby losses associated with coupling communication signals between the node B and the amplifier, and between the amplifier and the antenna are reduced over a 3G network not having a node B and an amplifier affixed to the top of the tower in a location proximal to the antenna.

16. A method according to claim 15, wherein losses associated with coupling communication signals between the antenna and the node B are reduced by at least 3 dB.

17. A method according to claim 15, wherein the step of amplifying and filtering communication signals passed between the node B and the UE comprises the step of transmitting an outgoing communication signal from the antenna having a power of at least 39 dBm.

18. A method according to claim 15, wherein the 3G network further comprises a radio network controller (RNC), and a backhaul affixed to the top of the tower in a location proximal to the antenna and configured to couple communication signals between the node B and the RNC, and wherein the method further comprises the step of coupling communication signals between the node B and the RNC using the backhaul.

19. A method according to claim 18, wherein the backhaul is configured to couple communication signals between the node B and the RNC via a 3G network, and wherein the step of coupling communication signals between the node B and the RNC using the backhaul comprises the step of coupling communication signals between the node B and the RNC via the 3G network.

20. A method according to claim 19, further comprising the step of supplying electrical power to the node B, the amplifier and the backhaul from at least one photovoltaic cell affixed to the tower.
